(19) United States
(12) Patent Application Publication
(10) Pub. No.: US 2018/0191433 A1
(43) Pub. Date: Jul. 5, 2018

(54) RATIOMETRIC CONTROL OF OPTICAL DEVICES

(71) Applicant: Aurrion, Inc., Goleta, CA (US)

(72) Inventors: John M. Garcia, Santa Barbara, CA (US); Erik Johan Norberg, Santa Barbara, CA (US); Anand Ramaswamy, Pasadena, CA (US); Robert Silvio Guzzon, Santa Barbara, CA (US)

(21) Appl. No.: 15/908,942

(22) Filed: Mar. 1, 2018

Related U.S. Application Data
(63) Continuation of application No. 14/528,834, filed on Oct. 30, 2014.

(51) Int. Cl. H04B 10/079

(52) U.S. Cl. CPC H04B 10/07955

(57) ABSTRACT

Embodiments of the invention comprise a photonic integrated circuit (PIC) including an optical device and a silicon integrated circuit (IC) (such as an application specific IC (ASIC)) including a controller for the optical device. The PIC and silicon IC are integrated on a shared substrate. The PIC further includes one or more monitor photodiodes (MPDs) that are monolithically integrated with the optical device; the monolithic integration of several optical components enables ratiometric control of the optical device. Simplified control processes are executed based on the detected MPD photocurrents, on the function of the optical device (e.g., whether the device as an SOA, modulator, or attenuator), and on the application of the optical device.

### FIELD

Embodiments of the invention generally pertain to the optical devices and more specifically to the calibration and runtime control of optical devices.

### BACKGROUND

Optical devices such as amplifiers, modulators, and attenuators require some form of initial device calibration and runtime operation control. Current solutions utilize discrete components for executing said calibration/control processes. For example, an electro-absorption modulator (EAM) requires discrete components—such as discrete optical taps and photodetectors, to measure power characteristics at its input and output; these measured power characteristics are used for determining how to calibrate and control the EAM in order to optimize its output. Factors such as discrete component coupling loss must be taken into account, and thereby create a complex calibration and control process. Furthermore, discrete components increase the overall device and system footprint.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is an optical device having a photonic integrated circuit and control circuitry according to an embodiment of the invention.

FIG. 2 is an integrated platform comprising control circuitry and a photonic integrated circuit according to an embodiment of the invention.

FIG. 3 is an illustration of an optical device having a photonic integrated circuit and control circuitry according to an embodiment of the invention.

FIG. 4 is a flow diagram of a process for controlling an optical device according to an embodiment of the invention.

Descriptions of certain details and implementations follow, including a description of the figures, which can depict some or all of the embodiments described below, as well as discussing other potential embodiments or implementations of the inventive concepts presented herein. An overview of embodiments of the invention is provided below, followed by a more detailed description with reference to the drawings.

### DESCRIPTION

Embodiments of the invention describe methods, systems, and apparatuses to execute ratiometric control processes for optical devices. Throughout this specification, several terms of art are used. These terms are to take on their ordinary meaning in the art from which they come, unless specifically defined herein or the context of their use would clearly suggest otherwise. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

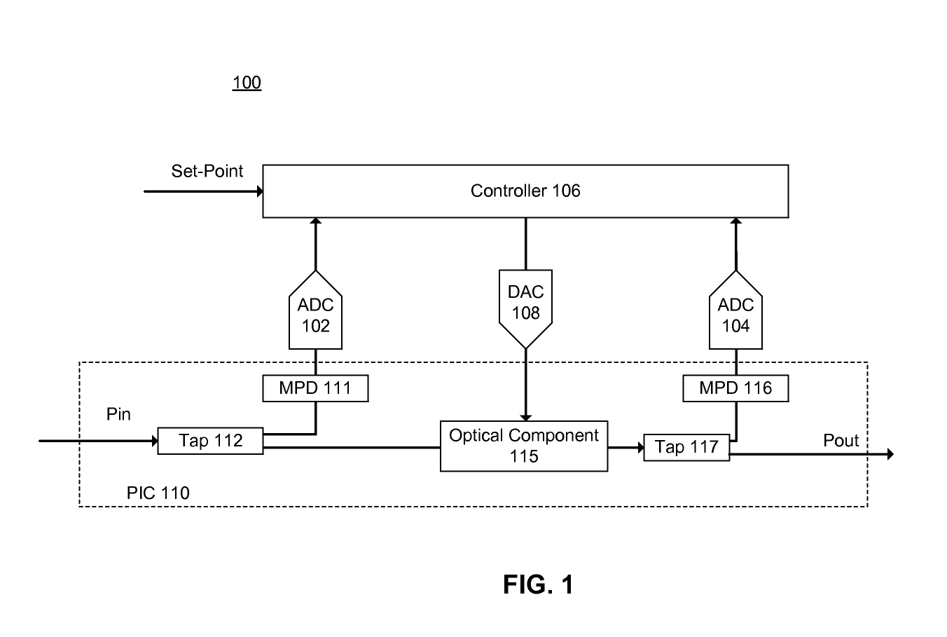

FIG. 1 is an optical device having a photonic integrated circuit (PIC) and control circuitry according to an embodiment of the invention. Device 100 is shown to include PIC 110, which further includes monitor photodiodes (MPDs) 111 and 116, optical taps 112 and 117, and optical component 115. Device 100 further includes control circuitry comprising analog-to-digital converters (ADCs) 102 and 104, digital-to-analog converter (DAC) 108, and controller 106. In embodiments of the invention, optical component 115 can comprise any optical component to receive an optical input (Pᵢₙ) and emit an optical output (Pₒᵤₜ)—such as an optical amplifier, modulator, or attenuator.

In this embodiment, the components of PIC 110 can all be monolithically integrated onto the same silicon on insulator (SOI) substrate; the control circuitry of device 100 can be included in a silicon integrated circuit (IC); the PIC and the IC can also share the same organic substrate. MPDs 111 and 116, taps 112 and 117, and optical component 115 can comprise the same or different optical material.

Taps 112 and 117 are utilized in this embodiment to extract a percentage of incoming PIC signal Pᵢₙ and outgoing PIC signal Pₒᵤₜ, respectively; these extracted signals are forwarded to MPDs 111 and 116, respectively, where photocurrent is generated via means of opto-electronic absorption. Taps 112 and 117 can comprise, for example, a directional and/or multi-mode interference (MMI) coupler. The MPD photocurrents are digitized using analog to digital converters (ADCs) 102 and 104; the outputs of these converters are utilized as an electronic feedback signal to digital controller 106. Said controller can comprise, for example, a proportional integral derivative (PID) controller for calculating an error value as a difference between the MPD photocurrents and a predetermined value. In this embodiment, controller 106 controls the operation of optical component 115 via control signals transmitted to the component via DAC 108.

In some embodiments, the optical power before tap 112 can be estimated by using the measured photocurrent and having previous knowledge of the designed tap splitting ratio and the photodiode responsivity of MPD 111; said MPD can be intentionally designed to exhibit an analog bandwidth significantly lower than an operational data rate such that the measured photocurrent value is representative of the average optical power. The portion of the signal that bypasses MPD 111 travels through optical component 115, where it can undergo any of amplification, modulation, attenuation, etc. The operation performed on the electronic feedback signal depends on the application and the function of the optical component.

In some embodiments, optical component 115 comprises an electro-absorption modulator (EAM). In these embodiments, the extinction ratio (ER) of the modulated signal output by the EAM is maximized via controller 106 by monitoring and maintaining a specific ratio between the photocurrents detected by MPDs 111 and 116. In these embodiments, the photocurrent measured at MPD 111 is representative of the input optical power, while the photocurrent measured at MPD 116 directly measures the total insertion loss (IL) of the EAM (i.e., optical component 115). The total insertion loss is comprised of losses intrinsic of the EAM in the absence of bias (IL_{EAM}) and losses incurred by modulation through absorption (IL_{MOD}). A modulated signal exhibiting low extinction ratio has a relatively small difference between the logical “1” and logical “0” level, which results in an average power comparable to the peak power and negligible modulation loss (i.e., IL_{MOD}˜0 dB). Conversely, an optical signal showing high extinction ratio has a relatively large difference between the “1” and “0” levels resulting in an average power level measuring less than the amplitude of the peak optical power. This inefficiency can be the result of runtime conditions of the EAM—for example, device temperature fluctuations. Thus, the digital control scheme to maximize the extinction ratio of the EAM can comprise measuring both input and output photocurrents, and adjusting the EAM bias accordingly in order to vary the modulation loss to achieve high modulation efficiency.

As described above, the components of PIC 100 are monolithically integrated on a common substrate. Utilization of a heterogeneous integration platform allows the MPDs utilized by embodiments to be fabricated of active material that is separate from the material comprising the optical device. In these embodiments, the MPDs can be reverse-biased using complementary metal-oxide-semiconductor (CMOS) compatible voltage levels, while achieving a relatively constant responsivity across wavelengths and a wide ambient temperature range. As a result, a reliable optical power reading is made available to controller 106 with minimal requirements on responsivity calibration.

Furthermore, in embodiments utilizing an EAM electro-absorption modulator integrated with optical taps and MPDs, the need to dither the modulator bias is eliminated and the control process eliminates the need to perform complex analog mixing/processing to account for discrete component coupling loss. Dithering the modulator bias is eliminated because the EAM output power transfer characteristics exhibit a monotonic relationship with the reverse bias (i.e., the EAM output power transfer characteristics are a monotonically increasing/decreasing function of the reverse bias), which allows the digital controller to have a known direction of bias adjustment. Utilizing an approach that forgoes dither sources and conventional analog mixing is more scalable, cost effective, and consumes less power while allowing the digital calibration and control of optical component 115 to be implemented using basic mathematic operations. In addition to EAMs, other types of optical components (e.g., switches, semiconductor optical amplifiers (SOAs), etc.) can have output power transfer characteristics that are a monotonically increasing/decreasing function of the reverse bias—e.g., an SOA bias current can be limited to a monotonic range.

In some embodiments, optical component 115 comprises a semiconductor optical amplifier (SOA) monolithically integrated with optical taps 112 and 117 and MPDs 111 and 116. The optical gain of the amplifier is adjusted by varying the amount of injected carriers through a current bias input, while the input and output optical power levels are measured by sensing the photocurrents of MPDs 111 and 116. In applications for constant output optical power, the SOA bias current can be adjusted to ensure that output photocurrent detected by MPD 116 is fixed at a predetermined value. In applications for constant gain, the amount of current injection is regulated to maintain a desired output-to-input photocurrent ratio corresponding to the desired gain setting; in other words, optical component 115 is controlled so that the ratio of the detected photocurrents from MPDs 116 and 111 match (or closely match) the desired output-to-input photocurrent ratio corresponding to the desired gain setting.

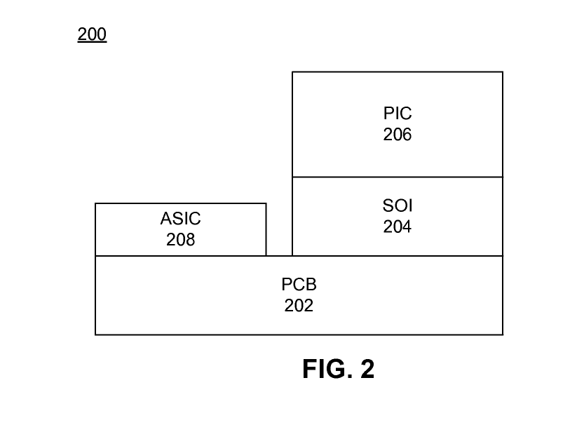

FIG. 2 is an integrated platform comprising control circuitry and a PIC according to an embodiment of the invention. In this embodiment, device 200 is shown to include printed circuit board substrate (PCB) 202, SOI substrate 204, PIC 206, and application specific integrated circuit (ASIC) 208. In some embodiments, the heterogeneous integration platform of device 200 comprises ASIC 208 formed from silicon material and PIC 206 formed from III-V semiconductor material and integrated onto SOI substrate 204. PCB substrate 202 can comprise any suitable substrate type, such as FR-2 substrate, FR-4 substrate, flex substrate, etc. This integrated platform allows for a compact form factor compared to an implementation using discrete components. Furthermore, monolithic integration minimizes the number of interfaces between semiconductor waveguides and free-space propagation regions, which reduces costs associated with packaging.

As described above and illustrated in FIG. 1, embodiments of the invention utilize integrated optical taps and MPDs in PIC 206; this integration with optical components (also included in PIC 206) minimizes the variation in tap to split ratio as optical taps such as directional MMI couplers can be fabricated with high repeatability. The necessity of having to calibrate each tap-MPD combination is effectively eliminated, along with coupling uncertainties that exist in discrete implementations of a tap-MPD combination. The elimination of these processes and uncertainties greatly simplifies the control process executed by the control circuitry of ASIC 208 for controlling for the optical components of PIC 206.

PIC 206 can comprise a plurality of active materials, such that the MPDs and the controlled optical components can be fabricated from the same or different active materials. Each device/component of a PIC can be made from different optimized materials, for example, by growing the materials separately, cutting (i.e., cleaving, etching, dicing, etc.) pieces of the different materials and bonding these pieces to SOI substrate 204. In some embodiments, photonic device layers are bonded so that shared (i.e., common) processing operations can be utilized to make more than one device/component simultaneously.

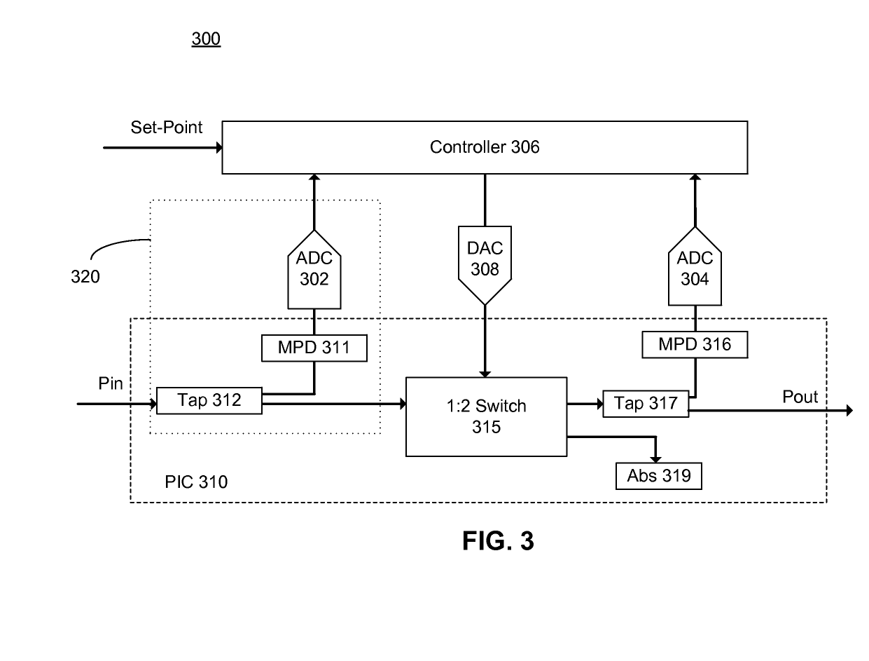

FIG. 3 is an illustration of an optical device having a PIC and control circuitry according to an embodiment of the invention. In this embodiment, device 300 includes PIC 310, which in this example includes a variable optical attenuator (VOA) comprising continuously tunable 1:2 optical switch 315 and absorber 319; said VOA is integrated with optical taps 312 and 317, and MPDs 311 and 316. Device 300 further includes control circuitry comprising ADCs 302 and 304, DAC 308, and controller 306.

Optical tap 312 and MPD 311 are placed at the input port of optical switch 315 to directly measure optical power levels entering the switching element (i.e., optical input (Pᵢₙ)). Optical tap 317 and MPD 316 are placed at one of the output ports of optical switch 315 to directly measure optical power levels exiting the switching element (i.e., optical output (Pₒᵤₜ)); another output port of the optical switch functions as a drop-port in this embodiment, and is terminated with absorber 319. This absorber can comprise an active material that is reverse-biased to serve as an optical absorber for any signal that is not routed towards the output port for Pₒᵤₜ.

In this embodiment, the switch state is continuously tuned by controller 306 adjusting the bias input (sent via DAC 308) for switch 315, while the measured MPD photocurrents are used as electronic feedback signals for the controller (sent via ADCs 302 and 304, respectively). In embodiments utilized for constant attenuation, the amount of switch bias is regulated to maintain a desired output-to-input MPD photocurrent ratio corresponding to the desired attenuation setting.

In embodiments utilized for a constant output optical power, the switch bias setting is adjusted to ensure that output MPD 316 photocurrent is fixed at a predetermined value (thus the components of sub-circuit 320 cannot be necessary for these embodiments, as only the measured photocurrent of output MPD 316 is used by the control circuitry). Other embodiments for controlling different optical components can similarly utilize a single tap-MPD combination. For example, control circuitry to control the gain of the SOA such that it is constant can utilize a photocurrent detected via a single MPD placed at the output of the SOA.

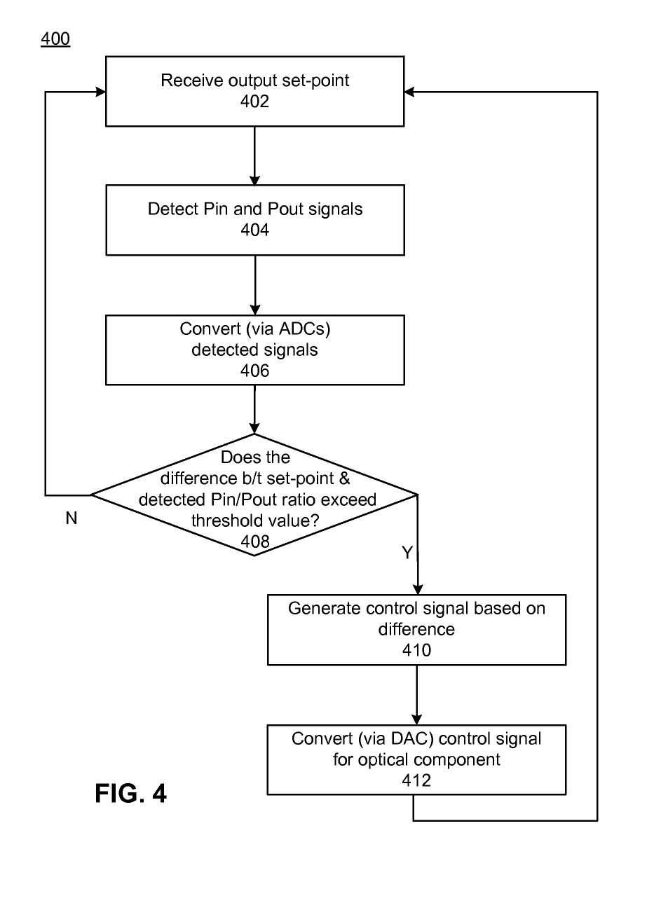

FIG. 4 is a flow diagram of a process for controlling an optical device according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions can be performed in parallel. Additionally, one or more actions can be omitted in various embodiments of the disclosure; thus, not all actions are required in every implementation. Other process flows are possible.

Process 400 can be executed by a PIC including an optical device and an ASIC including a controller for the optical device—both integrated on a shared substrate. Process 400 includes operations for the controller to receive an output set-point for the optical device, 402. As described above, this set-point can be related to the operational absorption or gain of the optical device. Pᵢₙ and Pₒᵤₜ signals are detected via optical taps and MPDs included in the PIC, 404; these signals are digitally converted (i.e., via ADCs) and sent to the controller, 406.

As the optical taps and MPDs are monolithically integrated with the optical device to be controlled, ratiometric control of the device is enabled without utilizing an electronic dither and without requiring complex control algorithms to account for associated discrete component coupling losses. Thus, the controller can simply determine if the difference between a ratio of detected Pᵢₙ and Pₒᵤₜ signals and the output set-point (i.e., a target ratio for the Pᵢₙ and Pₒᵤₜ signals) exceeds a threshold value—i.e., whether the Pᵢₙ/Pₒᵤₜ ratio indicates a significant deviation from a target gain or absorption value.

If the difference does not exceed the threshold value, then no adjustment to the optical device can be necessary, and the Pᵢₙ and Pₒᵤₜ signals can be subsequently re-measured at a frequency determined by the implemented control algorithm. If the difference does exceed the threshold value, then a control signal is generated to adjust the absorption or gain of the optical device accordingly, 410. This control signal is converted to an analog signal (i.e., via a DAC) to adjust the operation of the optical device, 412.

Reference throughout the foregoing specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout the specification are not necessarily all referring to the same embodiment. Furthermore, the particular features, structures or characteristics can be combined in any suitable manner in one or more embodiments. In addition, it is appreciated that the figures provided are for explanation purposes to persons ordinarily skilled in the art and that the drawings are not necessarily drawn to scale. It is to be understood that the various regions, layers and structures of figures can vary in size and dimensions.

The above described embodiments of the invention can comprise SOI or silicon based (e.g., silicon nitride (SiN)) devices, or can comprise devices formed from both silicon and a non-silicon material. Said non-silicon material (alternatively referred to as “heterogeneous material”) can comprise one of III-V material, magneto-optic material, or crystal substrate material.

III-V semiconductors have elements that are found in group III and group V of the periodic table (e.g., Indium Gallium Arsenide Phosphide (InGaAsP), Gallium Indium Arsenide Nitride (GaInAsN)). The carrier dispersion effects of III-V based materials can be significantly higher than in silicon based materials, as electron speed in III-V semiconductors is much faster than that in silicon. In addition, III-V materials have a direct bandgap which enables efficient creation of light from electrical pumping. Thus, III-V semiconductor materials enable photonic operations with an increased efficiency over silicon for both generating light and modulating the refractive index of light.

Thus, III-V semiconductor materials enable photonic operation with an increased efficiency at generating light from electricity and converting light back into electricity. The low optical loss and high quality oxides of silicon are thus combined with the electro-optic efficiency of III-V semiconductors in the heterogeneous optical devices described below; in embodiments of the invention, said heterogeneous devices utilize low loss heterogeneous optical waveguide transitions between the devices' heterogeneous and silicon-only waveguides.

Magneto-optic materials allow heterogeneous PICs to operate based on the magneto-optic (MO) effect. Such devices can utilize the Faraday Effect, in which the magnetic field associated with an electrical signal modulates an optical beam, offering high bandwidth modulation, and rotates the electric field of the optical mode enabling optical isolators. Said magneto-optic materials can comprise, for example, materials such as such as iron, cobalt, or yttrium iron garnet (YIG).

Crystal substrate materials provide heterogeneous PICs with a high electro-mechanical coupling, linear electro optic coefficient, low transmission loss, and stable physical and chemical properties. Said crystal substrate materials can comprise, for example, lithium niobate (LiNbO3) or lithium tantalate (LiTaO3).

Embodiments of the disclosure describe an optical device comprising a photonic integrated circuit (PIC) comprising a non-silicon semiconductor material and including an optical component comprising an input and an output, a first and a second monitor photodiodes (MPDs), a first optical tap to output an optical signal to both the input of the optical component and the first MPD, and a second optical tap to receive light from the output of the optical component and to output light to the second MPD. Control circuitry, comprising a silicon semiconductor material, can be configured to determine a ratio of the light received at the first MPD and the second MPD, and control an absorption or gain of the optical component in response to determining a difference between the measured ratio and a target ratio for light input to and output from the optical component. In some embodiments, the above described optical device can further comprise a common substrate integrating the PIC and the control circuitry.

In some embodiments, the optical component can comprise a modulator and the control circuitry is to control the absorption of the modulator. In some of these embodiments, the modulator can comprise an electro-absorption modulator (EAM) and the control circuitry is to monotonically control the absorption of the modulator based on the difference between the measured ratio and the target ratio.

In some embodiments, the optical component can comprise a semiconductor optical amplifier (SOA) and the control circuitry is to control the gain of the SOA. In some of these embodiments, the optical device can further comprise a second SOA not controlled by the control circuitry and to output a constant optical power. In some embodiments, the (first).

SOA is controlled maintain a constant measured ratio of the light received at the first MPD and the second MPD for the SOA operate with a constant gain.

In some embodiments, the optical component can comprise a variable optical attenuator (VOA) including a switch and an absorber, and the control circuitry is to control the absorption of the VOA by adjusting a bias input of the switch to control a switch state for directing an amount of light directed to the absorber; in some of these embodiments, the bias input of the switch can be regulated to maintain a constant measured ratio of the light received at the first MPD and the second MPD corresponding to a constant attenuation setting. The switch can comprise a Mach-Zehnder Interferometer (MZI) in some embodiments. The absorber can be coupled to a drop port of the switch in some embodiments.

In some embodiments, the first and second optical taps can each comprise a multi-mode interference (MMI) coupler. In some embodiments, the MPDs and the optical component each can comprise at least one different active material. In some embodiments, the MPDs and the optical component can each comprise the same active material.

Embodiments of the disclose described an optical device comprising a photonic integrated circuit (PIC) comprising a non-silicon semiconductor material and including an optical component comprising an input and an output, a monitor photodiode (MPD), and an optical tap to receive light from the output of the optical component and to output light to the MPD. Control circuitry, comprising a silicon semiconductor material, can be configured to control an absorption or gain of the optical component based on an operational set-point for the optical component and a photocurrent detected by the MPD. A common substrate can integrate the PIC and the control circuitry.

In some embodiments, the optical component can comprise an electro-absorption modulator (EAM) and the control circuitry is to control the absorption of the EAM to a constant value. In some embodiments, the optical component can comprise a semiconductor optical amplifier (SOA), and the control circuitry can control the gain of the SOA such that the photocurrent detected by the MPD is fixed at a predetermined value for the SOA to output a constant optical power.

In some embodiments, the optical component can comprise a variable optical attenuator (VOA) including a switch and an absorber, and the control circuitry can control the absorption of the VOA by adjusting a bias input of the switch to control the switch state for directing an amount of light directed to the absorber such that the photocurrent detected by the MPD is fixed at a predetermined value. In some of these embodiments, the switch can comprise a Mach-Zehnder Interferometer (MZI), and/or the absorber can be coupled to a drop port of the switch.

In some embodiments, the optical tap can comprise a multi-mode interference (MMI) coupler. In some embodiments, the MPD and the optical component can each comprise at least one different active material. In some embodiments, the MPD and the optical component each comprise the same active material.

In the foregoing detailed description, the method and apparatus of the present invention have been described with reference to specific exemplary embodiments thereof. It will, however, be evident that various modifications and changes can be made thereto without departing from the broader spirit and scope of the present invention. The present specification and figures are accordingly to be regarded as illustrative rather than restrictive.

1. (canceled)

2. An optical device, comprising:
an electro-absorption modulator configured to impart a data signal onto an input beam to form an output beam, the output beam including transitions in time between a first light level and a second light level greater than the first light level;
a first tap and a first sensor configured to detect a portion of the input beam and produce a first electrical signal that represents a light level of the input beam;
a second tap and a second sensor configured to detect a portion of the output beam and produce a second electrical signal that represents a time-averaged light level of the output beam; and
a controller configured to vary a reverse bias voltage of the electro-absorption modulator based at least in part on the first and second electrical signals, the reverse bias voltage selected such that a ratio of the second light level to the first light level exceeds a specified extinction ratio.

3. The optical device of claim 2, wherein:
the transitions between the first light level and the second light level occur at a data rate; and
the second sensor has an analog bandwidth less than the data rate.

4. The optical device of claim 3, wherein:
the first sensor has an analog bandwidth less than the data rate; and
the input beam does not include variations in light level that are faster than the analog bandwidth of the first sensor.

5. The optical device of claim 4, wherein the controller is further configured to apply a rapidly-varying voltage at the data rate to the electro-absorption modulator, the rapidly-varying voltage summing with the reverse bias voltage to cause the electro-absorption modulator to attenuate the input beam to the first light level and the second light level.

6. The optical device of claim 5, wherein the controller is configured to vary the reverse bias voltage, but not vary the rapidly-varying voltage, in response to the first and second electrical signals.

7. The optical device of claim 2, wherein the controller is further configured to vary the reverse bias voltage of the electro-absorption modulator in response to a ratio of the first and second electrical signals.

8. The optical device of claim 2, wherein the reverse bias voltage is selected such that:
the first light level is greater than zero; and
the second light level is less than a light level of the input beam.

9. The optical device of claim 2, wherein the time-averaged light level of the output beam is halfway between the first and second light levels.

10. The optical device of claim 9, wherein the reverse bias voltage is selected such that the time-averaged light level of the output beam is half of the light level of the input beam.

11. The optical device of claim 2, wherein the controller does not dither the reverse bias voltage.

12. A method, comprising:
imparting, with an electro-absorption modulator, a data signal onto an input beam to form an output beam, the output beam including transitions in time between a first light level and a second light level greater than the first light level;
detecting a portion of the input beam and produce a first electrical signal that represents a light level of the input beam;
detecting a portion of the output beam and produce a second electrical signal that represents a time-averaged light level of the output beam; and
varying a reverse bias voltage of the electro-absorption modulator based at least in part on the first and second electrical signals, the reverse bias voltage selected such that a ratio of the second light level to the first light level exceeds a specified extinction ratio.

13. The method of claim 12, wherein:
the transitions between the first light level and the second light level occur at a data rate; and
the portion of the output beam is detected with a sensor having an analog bandwidth less than the data rate.

14. The method of claim 12, wherein:
the portion of the input beam is detected with a sensor has an analog bandwidth less than the data rate; and
the input beam does not include variations in light level that are faster than the analog bandwidth.

15. The method of claim 14, further comprising:
applying a rapidly-varying voltage at the data rate to the electro-absorption modulator, the rapidly-varying voltage summing with the reverse bias voltage to cause the electro-absorption modulator to attenuate the input beam to the first light level and the second light level.

16. The method of claim 15, further comprising varying the reverse bias voltage, but not vary the rapidly-varying voltage, in response to the first and second electrical signals.

17. The method of claim 12, further comprising varying the reverse bias voltage of the electro-absorption modulator in response to a ratio of the first and second electrical signals.

18. The method of claim 12, wherein the reverse bias voltage is selected such that:
the first light level is greater than zero; and
the second light level is less than a light level of the input beam.

19. An optical device, comprising:
an electro-absorption modulator configured to impart a data signal onto an input beam to form an output beam, the output beam including transitions in time between a first light level and a second light level greater than the first light level, the transitions in time occurring at a data rate;
a first tap and a first sensor configured to detect a portion of the input beam and produce a first electrical signal that represents a light level of the input beam;
a second tap and a second sensor configured to detect a portion of the output beam and produce a second electrical signal that represents a time-averaged light level of the output beam, the second sensor having an analog bandwidth less than the data rate, the time-averaged light level being between the first and second light levels; and
a controller configured to apply a modulator voltage to the electro-absorption modulator, the modulator voltage including a rapidly-varying component at the data rate summed with a slowly-varying component, the controller configured to vary the slowly-varying component in response to a ratio of the first and second electrical signals to cause a ratio of the second light level to the first light level to equal or exceed a specified extinction ratio.

20. The optical device of claim 19, further comprising varying the slowly-varying component, but not vary the rapidly-varying component, in response to the ratio of the first and second electrical signals.

21. The optical device of claim 19, wherein the controller does not dither the reverse bias voltage.
